(19) United States
(12) Patent Application Publication
(10) Pub. No.: US 2021/0316553 A1
(43) Pub. Date: Oct. 14, 2021

(54) CURVED FLUID EJECTION MODULES

(71) Applicant: Hewlett-Packard Development Company, L.P., Spring, TX (US)

(72) Inventors: Chien-Hua Chen, Corvallis, OR (US); Michael W. Cumbie, Corvallis, OR (US)

(73) Assignee: Hewlett-Packard Development Company, L.P., Spring, TX (US)

(21) Appl. No.: 17/273,333

(22) PCT Filed: Nov. 21, 2018
(86) PCT No.: PCT/US2018/062291

§ 371 Date: Mar. 4, 2021

(51) Int. Cl. B41J 2/16; B29C 65/00; B29C 53/04

(52) U.S. Cl. CPC B41J 2/1637; B41J 2/1623; B29C 66/7392; B29K 2105/243; B41J 2/1632; B41J 2202/20; B29C 53/04

(57) ABSTRACT

A fluid ejection module may include a plurality of fluid ejection dies coupled to a thermoset material and singulated, and a thermoplastic material coupled to the singulated, fluid ejection dies. The thermoplastic material may be bent to form a curvature in the fluid ejection module.

### BACKGROUND

Printing devices contain a number of fluid ejection devices or modules such as printheads used to dispense ink or another jettable fluid onto a print medium. The printheads include a number of dies that are precision dispensing devices that precisely dispense the jettable fluid to form an image on the print medium. The jettable fluid may be delivered via a fluid slot defined in the print head to an ejection chamber beneath a nozzle. Fluid may be ejected from the ejection chamber by, for example, heating a resistive element. The ejection chamber and resistive element form the thermal fluid ejection device of a thermal inkjet (TIJ) printhead. The printing devices may, however, use any type of digital, high precision liquid dispensing system, such as, for example, two-dimensional printing systems, three-dimensional printing systems, digital titration systems, and piezoelectric printing systems, among other types of printing devices.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a printhead including collinear dies.

FIG. 2 is a block diagram of a curved printhead including dies that curve with respect to a surface of a print medium, according to an example of the principles described herein.

FIGS. 3, 4A-4B, 5A-5B, 6A-6B, and 7A-7B are a series of block diagrams of a method of manufacturing a fluid ejection device, according to an example of the principles described herein.

FIG. 8 is a block diagram of a mold for use in shaping a printhead, according to an example of the principles described herein.

FIG. 9 is a flowchart showing a method of manufacturing a fluid ejection device, according to an example of the principles described herein.

FIG. 10 is a flowchart showing a method of manufacturing a fluid ejection device, according to an example of the principles described herein.

FIG. 11 is a flowchart showing a method of manufacturing a fluid ejection device, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A print media path defines the path print media such as a web or paper takes during a printing process. During the printing process, a printing substance such as an ink or toner is deposited onto the print media. Within the print media path, the print media may be directed by a number of rollers that cause the print media to wrap around the rollers. The print media is eventually brought into printing interface with a printhead that dispenses the printing substance onto the print media. A roller may be included next to the printhead to direct the print media past the printhead.

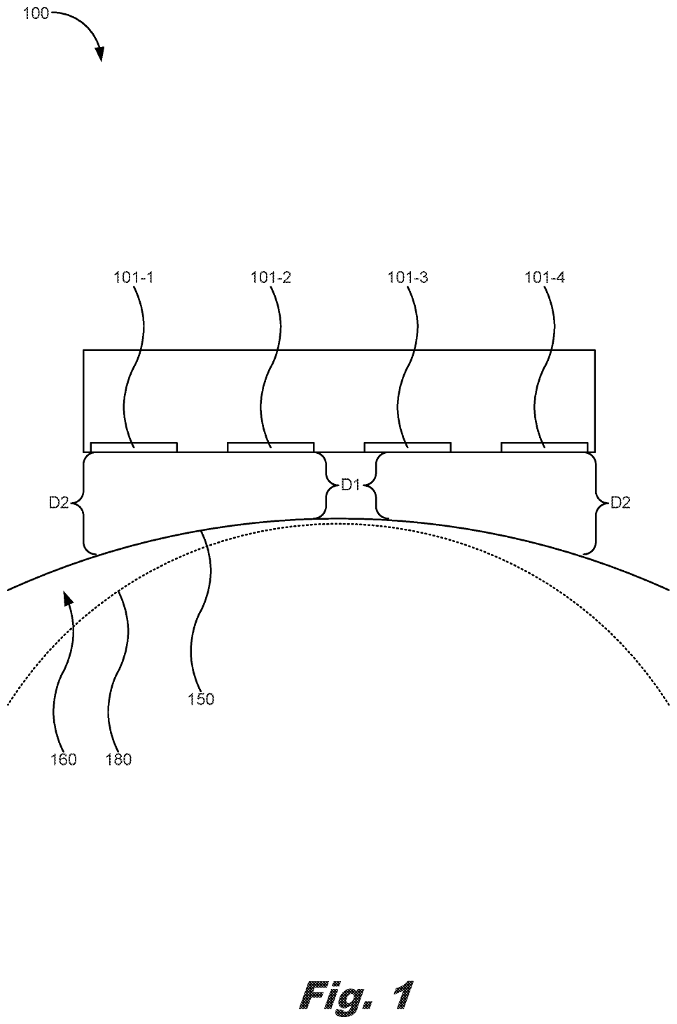

The printhead may include a plurality of rows of printing dies that dispense the printing substance from the printhead. In some instances, the dies of the printhead may be collinear with one another. FIG. 1 is a block diagram of a printhead (100) including collinear fluid ejection dies (101-1, 101-2, 101-3, 101-4, collectively referred to herein as 101). Throughout the description, the terms “fluid ejection dies” and “dies” are used exchangeably to mean any device that ejects fluid from the printhead (100). The printhead (100) includes the dies (101) arranged collinearly with respect to one another. A roller (180) carries a print medium (150) such that the print medium (150) is placed next to the printhead (100) and its collinear dies (101). A gap (160) may exist between the print medium (150) and the roller (180). The gap (160) is created as the print medium (150) is pulled taunt across a top or crown of the roller (180) and is moved within a printing device via other rollers. In this manner, the radius of the curvature of the print medium (150) over the roller (180) may be greater than the radius of the roller (180) itself.

However, due to the curvature of the print medium (150) across the roller (180), the distances between the various dies (101) is different. For example, the distance D1 between dies (101-2, 101-3) and the print medium (150) is different than the distance D2 between dies (101-1, 101-4) and the print medium (150). This difference in distances between the dies (101) and the print medium (150) may cause defects in the finished print when the dies (101) print a printing fluid onto the print medium (150). For example, dies (101-2, 101-3) may print in one manner onto the print medium (150), while the print substance dispensed by dies (101-1, 101-4) take more time to travel through the air between the dies (101-1, 101-4) and the print medium (150).

Further, dies (101-1, 101-4) are angled differently with respect to a surface of the print medium (150) as compared to the angle at which dies (101-2, 101-3) are positioned relative to the surface of the print medium (150). These and other differences between dies (101-1, 101-4) and dies (101-2, 101-3) and their positioning relative to the print medium (150) may cause blurring, stretching, distortions, or other print quality issues. Thus, a deviation of printhead (100) to print medium (150) spacing may be formed due to the collinear arrangement of the dies (101).

Examples described herein provide a curved printhead that matches the radius of a print medium moved within a printing device over a roller. Since the overmolded dies are much narrower than other dies, it is much easier to integrate the dies in a curved and insert molded printhead.

Singulation of the fluid ejection dies coupled to the thermoset material may include cutting the thermoset material along the sides of the fluid ejection dies. The terms “fluid ejection device” and fluid ejection modules” are used synonymously herein. The fluid ejection device may include ink feed channels formed in the thermoset material to feed a print fluid to the fluid ejection dies. The thermoset material may be an epoxy mold compound (EMC). The thermoplastic material may be, for example, an acrylic, poly(methyl methacrylate) (PMMA), acrylonitrile butadiene styrene (ABS), a nylon, polylactic acid (polylactide), polybenzimidazole (PBI), polycarbonate (PC), polyether sulfone (PES), polyoxymethylene (POM), polyether ether ketone (PEEK), polyetherimide (PEI), polyethylene (PE), polyphenylene oxide (PPO), polyphenylene sulfide (PPS), polypropylene (PP), polystyrene (PS), polyvinyl chloride (PVC), polytetrafluoroethylene (PTFE), polyethylene terephthalate (PET), or polysulfone (PSU). application of heat to the thermoplastic material causes the plurality of fluid ejection dies to be angled with respect to one another. The angle of the plurality of fluid ejection dies creates the curvature in the fluid ejection device.

Examples described herein also provide a printing system. The printing system may include a roller to convey a print medium, and a fluid ejection device to eject fluid onto the print medium. The fluid ejection device may include a plurality of fluid ejection dies coupled to a thermoset material and singulated, and a thermoplastic material coupled to the singulated, fluid ejection dies. The thermoplastic material is bent to form a curvature in the fluid ejection device.

The curvature in the fluid ejection device matches a radius of the print medium over the roller. The curve maintains each of the fluid ejection dies equidistant from the print medium.

Examples described herein also provide a method of manufacturing a fluid ejection device. The method may include coupling a plurality of fluid ejection dies to a thermoset material, singulating the thermoset material around the fluid ejection dies, coupling the singulated fluid ejection dies to a thermoplastic material, and heating the thermoplastic material to cause the plurality of fluid ejection dies to be angled with respect to one another. The angle of the plurality of fluid ejection dies creates a curve in the fluid ejection device.

The method may include forming a plurality of ink feed channels within the thermoset material to feed a print fluid to each of the fluid ejection dies. The method may also include placing the thermoplastic material and singulated fluid ejection dies into a mold, and heating the thermoplastic material. The mold defines the degree of curvature of the fluid ejection device. Singulation of the overmolded fluid ejection dies may include overmolding the plurality of fluid ejection dies within the thermoset material, and cutting the thermoset material along the sides of the fluid ejection dies. The thermoset material may be an epoxy mold compound (EMC). The method may also include cooling the thermoplastic-overmolded fluid ejection dies while in the curved state.

As used in the present specification and in the appended claims, the term “thermoset material” is meant to be understood broadly as any material which becomes irreversibly hardened upon being cured. Curing is caused by the action of heat or suitable radiation and results in extensive cross-linking between polymer chains to give an infusible and insoluble polymer network. A cured thermosetting material may be referred to as a thermoset.

As used in the present specification and in the appended claims, the term “thermoplastic material” is meant to be understood broadly as any material that becomes pliable or moldable above a specific temperature and solidifies upon cooling.

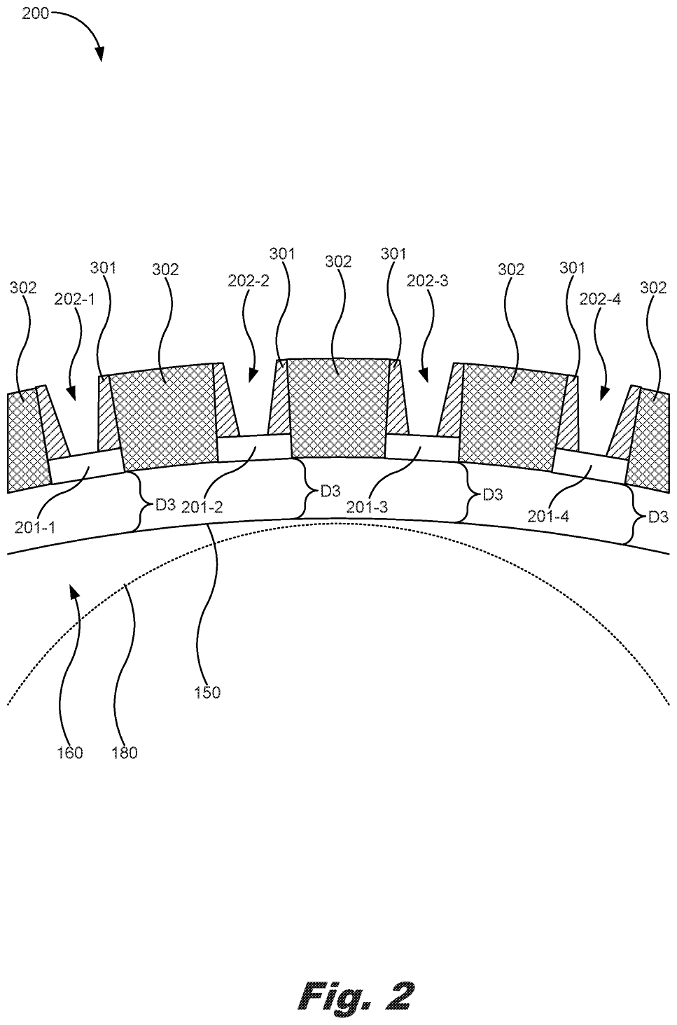

Turning again to the figures, FIG. 2 is a block diagram of a curved printhead (200) including fluid ejection dies (201-1, 201-2, 201-3, 201-4, collectively referred to herein as 201) that curve with respect to a surface of a print medium (150), according to an example of the principles described herein. In the examples described herein, the dies (201) may eject different substances such as, for example, different colors of printable fluid such as cyan (C), magenta (M), yellow (Y), and black (B).

In order to ensure that each of the dies (201) are equidistant from the print medium (150) as opposed to collinear as depicted in FIG. 1, the printhead (200) may include a curved form factor that matches a radius of the print medium (150) created by the roller (180) and the movement of the print medium (150) over the roller (180). In particular, a layer of thermoset material (301) such as an epoxy mold compound (EMC) may be overmolded around the dies (201). The overmolded dies (201) may be singulated to form a plurality of individual dies with a portion of the thermoset material (301) coupled to each of the singulated dies (201).

A thermoplastic material (302) may be overmolded over the singulated dies (201) such that the thermoplastic material (302) is formed between the singulated dies (201) fixing the singulated dies (201) in place and creating an array of dies (201) within the printhead (200). Although the printhead (200) at this non-curved state may function as a printhead, the curvature of the printhead (200) may be formed in order to match a radius of the print medium (150) created by the roller (180) and the movement of the print medium (150) over the roller (180). Thus, the printhead (200) may be shaped to include the curve by softening the thermoplastic material (302) between the singulated dies (201).

The thermoplastic material (302) may be any plastic material capable of plastically deforming when heated. Stated another way, a thermoplastic material (302) may be any material that becomes pliable or moldable above a specific temperature and solidifies upon cooling. The thermoplastic material (302) may be, for example, an acrylic, poly(methyl methacrylate) (PMMA), acrylonitrile butadiene styrene (ABS), a nylon, polylactic acid (polylactide), polybenzimidazole (PBI), polycarbonate (PC), polyether sulfone (PES), polyoxymethylene (POM), polyether ether ketone (PEEK), polyetherimide (PEI), polyethylene (PE), polyphenylene oxide (PPO), polyphenylene sulfide (PPS), polypropylene (PP), polystyrene (PS), polyvinyl chloride (PVC), polytetrafluoroethylene (PTFE), polyethylene terephthalate (PET), or polysulfone (PSU).

The thermoplastic material (302) may have a high molecular weight. The polymer chains of the thermoplastic material (302) associate through intermolecular forces, which weaken rapidly with increased temperature, yielding a viscous liquid. Thus, the thermoplastic material (302) may be reshaped by heating. Thus, the thermoplastic material (302) differs from the thermoset material (301) such as the EMC, which form irreversible chemical bonds during the curing process. The thermoset material (301) does not melt when heated, but instead decompose and do not reform upon cooling. Above its glass transition temperature and below its melting point, the physical properties of the thermoplastic material (302) change drastically without an associated phase change. In one example, the thermoplastic material (302) may be capable of repeatedly softening on heating and hardening on cooling.

Once heat is applied to the printhead (200) above a moldable temperature of the thermoplastic material (302), the thermoplastic material (302) may become pliable and moldable. At this point, the printhead (200) may be bent and shaped at the portions of the printhead (200) where the thermoplastic material (302) is located.

The thermoset material (301) and the thermoplastic material (302) are used to overmold the dies (201). By overmolding the dies (201), the dies (201) may be made smaller resulting in less cost in manufacturing the printhead (200) by eliminating large amounts of relatively more expensive materials such as silicon from which the dies (201) are made. Thus, the use of sliver dies (201) along with the overmold material greatly decreases manufacturing costs, and, in the examples described herein, are able to be modified to create a curvature in the printhead (200) that matches a curvature of a print medium (150) as curved over a roller (180).

In the examples described herein, the dies (201) may be positioned within the thermoset material (301) and the thermoplastic material (302) at a 1,524 micrometer (μm) pitch. Further the dies (201) may be embedded in 500 μm thick layers of the thermoset material (301) and the thermoplastic material (302). In an example, the dies (201) may be sliver dies. A sliver die may include a thin silicon, glass, or other substrate having a thickness on the order of approximately 650 μm or less, and a ratio of length to width (L/W) of at least three.

In the examples described herein, the dies (201) may be formed from silicon (Si). In another example, the dies (201) may be formed from glass or other materials instead of or in combination with silicon. For example, the printheads (200) described herein may include some dies (201) formed from silicon and some dies formed from another material such as glass.

The curved printhead (200) may also include fluid feed channels (202-1, 202-2, 202-3, 202-4, collectively referred to herein as 202) formed in the at least one layer of EMC. The fluid feed channels (202) serve to feed a printing fluid to the fluid ejection dies (201). In one example, the fluid feed channels (202) may be formed by removing portions of the thermoset material (301) to form the fluid feed channels (202). Removal of the thermoset material (301) may include cutting, mechanical etching, chemical etching, or other material removal processes. In another example, the fluid feed channels (202) may be formed through a molding process where the non-ejection sides of the dies (201) are interfaced with a protruding portion of a mold.

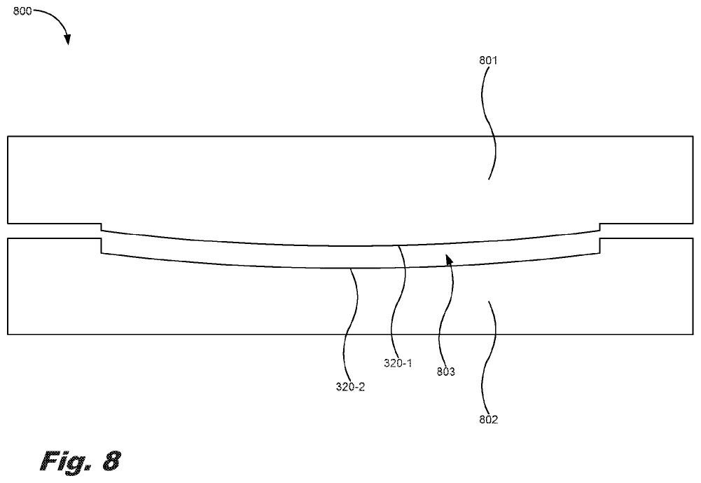

In one example, the curvature of the printhead (200) may be formed by placing the thermoset material (301), the thermoplastic material (302), and the dies (201) into a mold that is shaped to include a curve as depicted in FIG. 8. In this example, the mold cavity with its curved surfaces may be used to shape the printhead (200) alone or in combination with the thermoset material (301) and the thermoplastic material (302). The type of molding processes used in connection with this example of molding may include, for example, compression molding, transfer molding, injection molding, or combinations thereof.

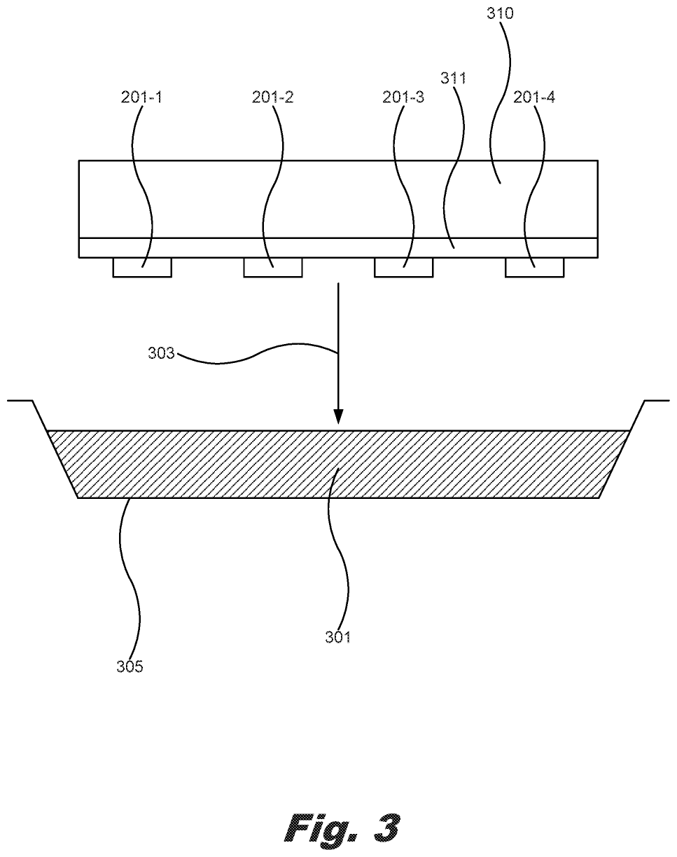

The arrangement of the dies (201) and the process used to form the curved printhead (200) causes the plurality of fluid ejection dies (201) to be non-planar with respect to one another at curing of the thermoset material (301) and the thermoplastic material (302). The non-planar arrangement of the plurality of fluid ejection dies (201) creates a curve in the curved printhead device (200). More details regarding the thermoset material (301) and the thermoplastic material (302) and the process by which the printhead (200) in these two examples are formed are provided herein in connection with FIGS. 3 through 7B.

FIGS. 3 through 7B are a series of block diagrams of a method of manufacturing a fluid ejection device (300), according to an example of the principles described herein. Specifically, FIGS. 3 through 7B depict the method of manufacturing the printhead (300) using the thermoset material (301) and the thermoplastic material (302) to form a curve in the printhead (300).

Beginning at FIG. 3, a number of dies (201) are adhered to a temporary substrate (310) via an adhesive layer (311). The temporary substrate (310) and adhesive layer (311) are used to correctly position and align the dies (201) with respect to one another. A reservoir of the thermoset material (301) such as an EMC material may be placed in a receptacle (305). The dies (201) are then brought into contact with the thermoset material (301) in an overmolding manner as depicted by arrow 303. The thermoset material (301) covers all sides of the dies (201) except a fluid ejection side of the dies (201). The thermoset material (301) is allowed to cure. “Curing” as used herein in the context of polymer chemistry and process engineering refers to the toughening or hardening of a polymer material by cross-linking of polymer chains, brought about by electron beams, heat, or chemical additives. The viscosity of, for example, the EMC drops initially upon the application of electron beams, heat, or chemical additives, passes through a region of maximum flow and begins to increase as the chemical reactions increase the average length and the degree of cross-linking between the constituent oligomers. This process continues until a continuous 3-dimensional network of oligomer chains is created that is referred to as gelation. In terms of processability of the EMC, before gelation the EMC may be relatively mobile, and after gelation the mobility is limited. At this point, the micro-structure of the EMC. Thus, in order to achieve vitrification in the EMC, the process temperature may be increased after gelation.

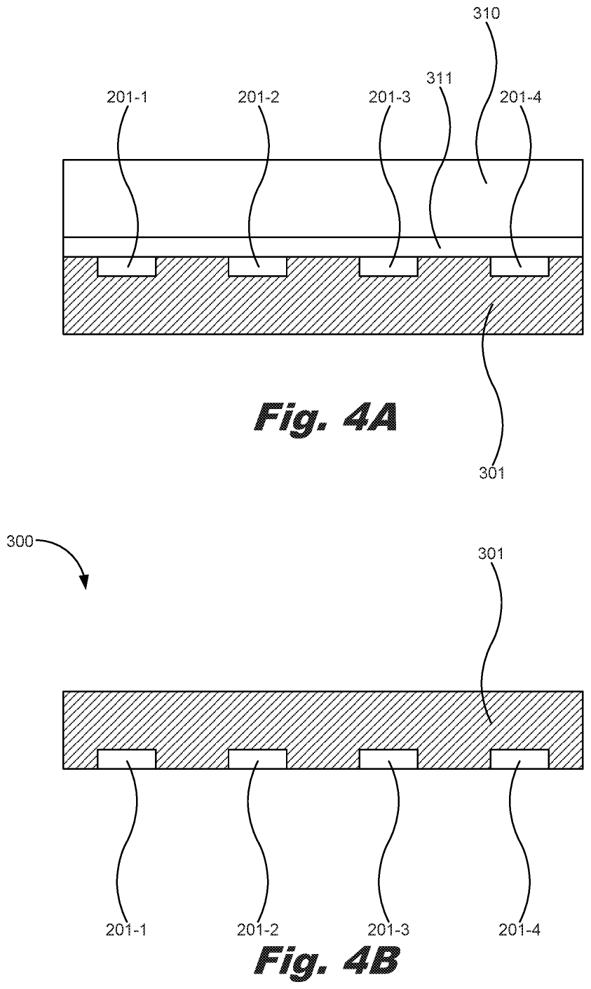

A cured layer of thermoset material (301) is depicted in FIG. 4A where the dies (201) are overmolded with the thermoset material (301) and the temporary substrate (310) is adhered to the dies (201) and the thermoset material (301) via the adhesive layer (311). In FIG. 4B, the adhesive layer (311) and temporary substrate (310) are removed. The orientation of the dies (201) and the EMC layer (301) is flipped about the horizontal axis between FIGS. 4A and 4B.

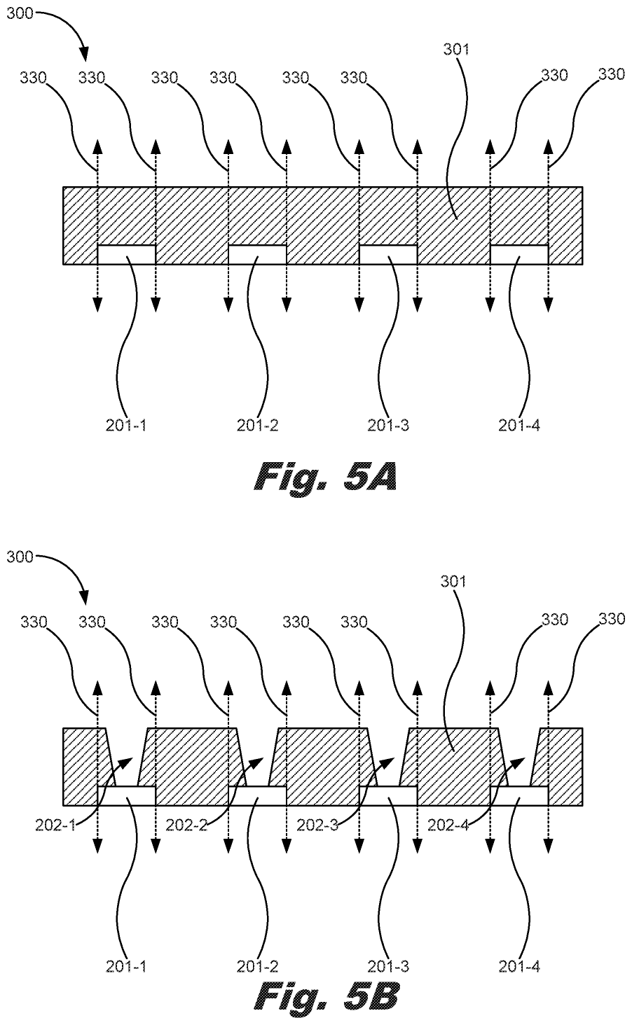

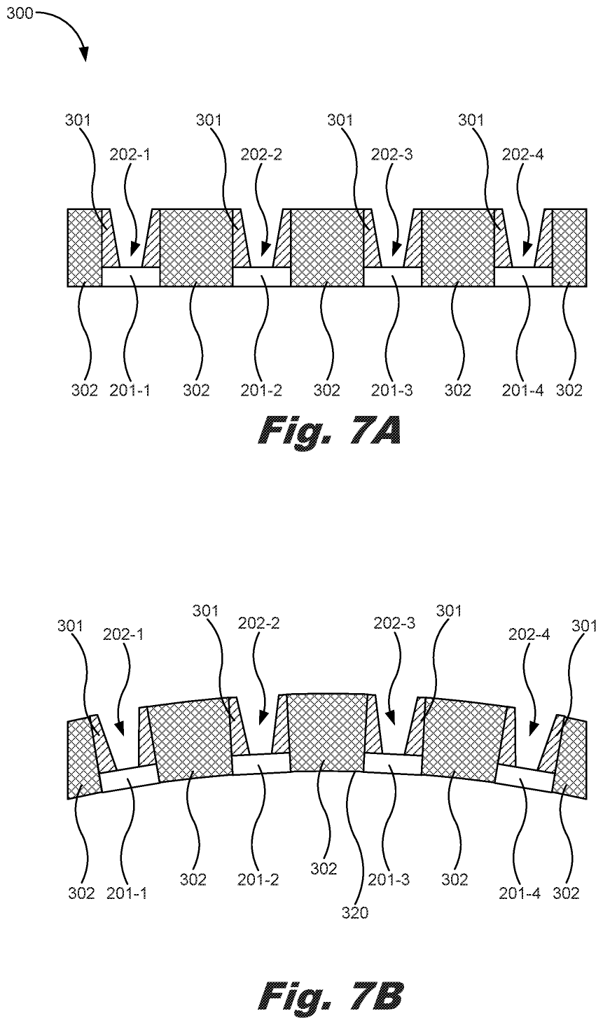

In FIG. 5A, the layer of thermoset material (301) has fully cured, and the dies (201) are prepared for the formation of fluid feed channels (202) within the thermoset material (301) and the singulation of the dies (201) within the overmolding of thermoset material (301). In FIG. 5A, lines 330 designate the lines at which the die (300) is cut to singulate the dies (201) leaving little thermoset material (301) around the dies (201) and no thermoset material (301) beyond the lines (330). However, before singulation, the fluid feed channels (202) are formed in the thermoset material (301) as depicted in FIG. 5B. The fluid feed channels (202) serve to feed a printing fluid to the fluid ejection dies (201). In one example, the fluid feed channels (202) may be formed by removing portions of the thermoset material (301) to form the fluid feed channels (202). Removal of the portions of the thermoset material (301) may include cutting, mechanical etching, chemical etching, or other material removal processes. In another example, the fluid feed channels (202) may be formed through a molding process where the non-ejection sides of the dies (201) are interfaced with a protruding portion of a mold. Although the fluid feed channels (202) are described herein as being formed at this point in the manufacturing process, the fluid feed channels (201) may be formed at other times in the thermoset material (301) including, for example, at or after the processes depicted and described in connection with FIG. 7A. However, formation of the fluid feed channels at FIG. 5B provide a state within the overall manufacturing process in which the thermoset material (301) is most robust and can be manipulated more easily.

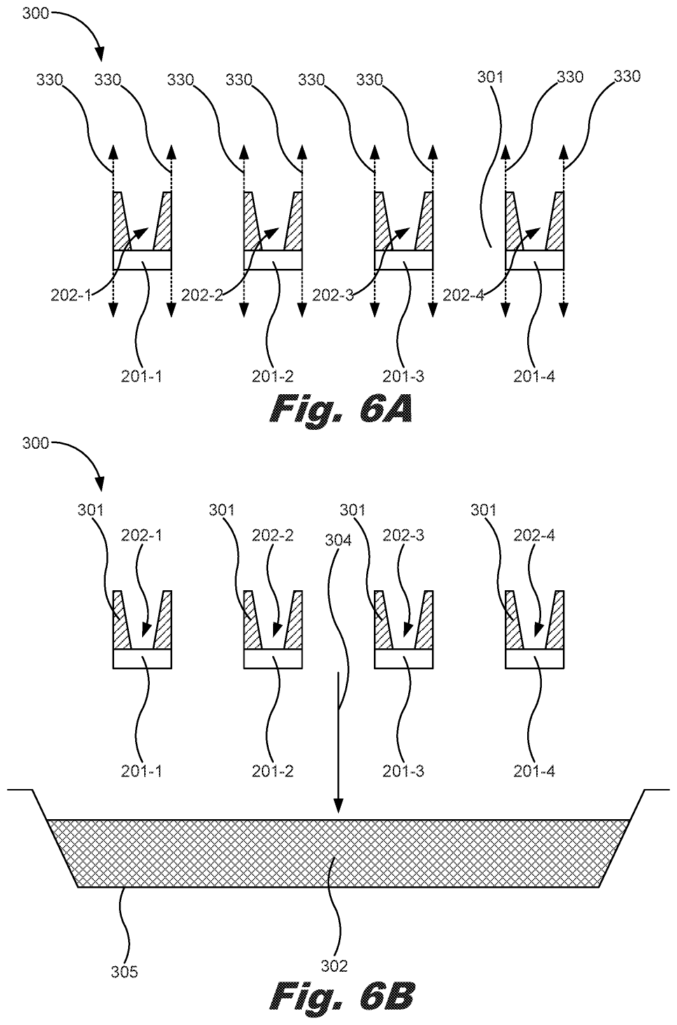

At FIG. 6A, the dies (201) are singulated along the singulation lines (330). Singulation may include cutting, mechanical etching, chemical etching, or other material removal processes. The singulation lines (330) run perpendicular to the printhead (300) and leave a relatively small portion of the thermoset material (301) remaining above the dies (201) and little or no thermoset material (301) beyond the lines (330). Although a relatively small portion of the thermoset material (301) is left after the singulation of the dies (201), this portion of the thermoset material (301) serves to provide strength to the overall structure of the printhead (300).

At FIG. 6B, the singulated dies (201) may be brought into contact with the thermoplastic material (302) in an overmolding manner as depicted by arrow 304. As an alternative, injection molding can be used for the purpose as well. In this example, the thermoplastic material (302) is not allowed to touch the fluid ejection sides of the dies (201), and in one example, the thermoplastic material (302) may be, instead, allowed to flow around and between the singulated dies (201) rather than dipping the singulated dies (201) into the reservoir (305) full of thermoplastic material (302).

At FIG. 7A, the thermoplastic material (302) may be allowed to cool and solidify based on its thermoplastic properties. At this state depicted in FIG. 7A, the printhead (300) does function as a printhead (300), but includes a coplanar arrangement similar to that arrangement depicted in FIG. 1. In order to ensure that each of the dies (201) are equidistant from the print medium (150) as opposed to collinear as depicted in FIG. 1, the printhead (300) may include a curved form factor that matches a radius of the print medium (150) created by the roller (180) and the movement of the print medium (150) over the roller (180). Thus, at FIG. 7B, the printhead (300) and, in particular, the thermoplastic material (302) may be exposed to heat in order to make the thermoplastic material (302) relatively more pliable or moldable. In this state, the thermoplastic material (302) may be bent and shaped to form the curve (320) depicted in FIG. 7B. In this manner, the printhead (300) may be shaped along the curve (320) via heating of the thermoplastic material (302) to match a radius of the print medium (150) created by the roller (180) and the movement of the print medium (150) over the roller (180).

FIG. 8 is a block diagram of a mold for use in shaping a printhead (200, 300), according to an example of the principles described herein. As described herein, the curvature of the printhead (200, 300) may be formed by placing the thermoset material (301), the thermoplastic material (302), and the dies (201) into the mold (900) that is shaped to include a curve (320-1, 320-2) as depicted in FIG. 8. Two halves (801, 802) of the mold (800) each include the curve (320-1, 320-2) that matches the curvature of the print medium (150) created by the roller (180) and the movement of the print medium (150) over the roller (180). In this example, the mold cavity (803) with the curved surfaces (320-1, 320-2) may be used to shape the printhead (200, 300). In one example, the two halves (801, 802) of the mold (800) may be heated or may include heating elements to impart heat to the printhead (200, 300) and the thermoplastic material (302) thereof. In this manner, the mold (800) may be used to shape the printhead (200, 300) through the application of heat. In one example, the printhead (300) as depicted in FIG. 7A with its coplanar arrangement of dies (201) may be placed into the mold (800). The mold (800) may heat the printhead (200, 300) and the thermoplastic material (302) thereof to create the curved shape (320) depicted in FIG. 7B. In other examples, the type of molding processes used in connection with this example of molding may include, for example, compression molding, transfer molding, injection molding, or combinations thereof. In one example, the two halves (801, 802) of the mold (800) may include a matching curved shape (320-1, 320-2) to create the curved printhead surface (320). In another example, the two curved surfaces (320-1, 320-2) may be different to create different radii of curvature on the two sides of the printhead (200, 300, 400).

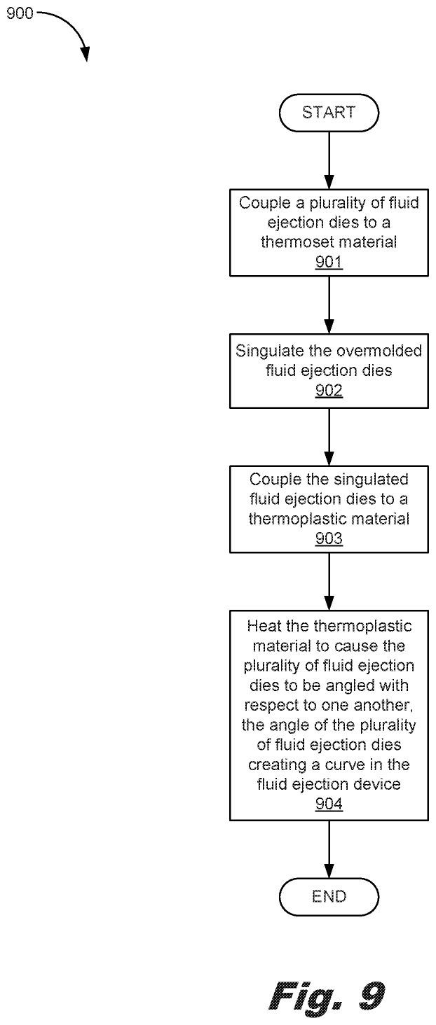

FIG. 9 is a flowchart showing a method (900) of manufacturing a fluid ejection device (200, 300), according to an example of the principles described herein. The method (900) may include coupling (block 901) a plurality of fluid ejection dies (201) to a thermoset material (301) such as an epoxy mold compound (EMC). Coupling (block 901) of the dies (201) to the thermoset material (301) may include overmolding the dies (201) with the dies (201) to a thermoset material (301). The dies (201) and the thermoset material (301) around the dies (201) may be singulated (block 902), and the singulated dies (201) may be coupled to the thermoplastic material (302). Coupling of the thermoplastic material (302) to the singulated dies (201) may include allowing the thermoplastic material (302) to flow between the singulated dies (201).

The method (900) may also include heating (block 904) the thermoplastic material (302) to cause the plurality of dies (201) to be angled with respect to one another. The angle of the plurality of dies (201) creates a curve (320) in the fluid ejection device (200, 300) that matches a radius of the print medium (150) created by the roller (180) and the movement of the print medium (150) over the roller (180).

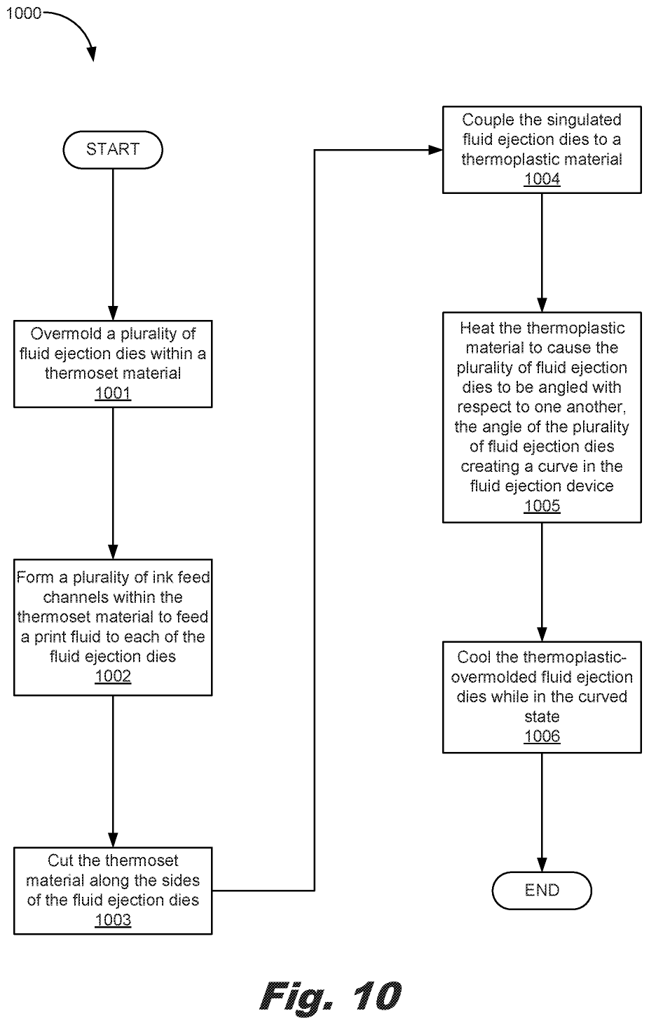

FIG. 10 is a flowchart showing a method (1000) of manufacturing a fluid ejection device (200, 300), according to an example of the principles described herein. The method (1000) may include overmolding (block 1001) a plurality of dies (201) within the thermoset material (301), and forming (block 1002) a plurality of ink feed channels (202) within the thermoset material (301) to feed a print fluid to each of the fluid ejection dies (201). The method may also include cutting (block 1003) the thermoset material (301) along the sides of the dies (201) in order to singulate the dies (201).

The singulated dies (1004) may be coupled (block 1004) to the thermoplastic material (302). Coupling of the thermoplastic material (302) to the singulated dies (201) may include allowing the thermoplastic material (302) to flow between the singulated dies (201). At block 1005, the thermoplastic material (302) may be heated to cause the plurality of dies (201) to be angled with respect to one another. The angle of the plurality of fluid ejection dies (201) creates a curve (320) in the fluid ejection device (200, 300).

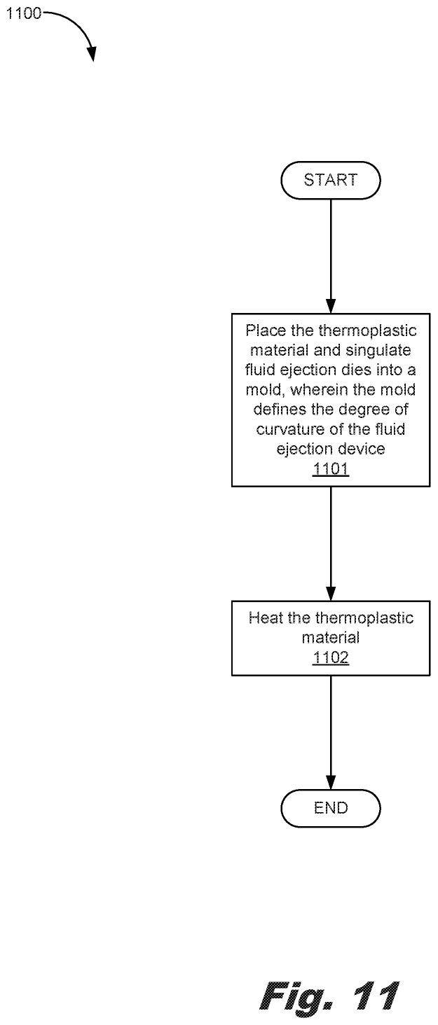

FIG. 11 is a flowchart showing a method (1100) of manufacturing a fluid ejection device (200, 300), according to an example of the principles described herein. The method (1100) of FIG. 11 may include placing the thermoplastic material (302) and the singulated dies (201) that have been overmolded with a thermoset material (301) into a mold (800) such as the mold (800) depicted in FIG. 8. The mold (800) defines the degree of curvature of the fluid ejection device (200, 300). The thermoplastic material (302) of the printhead (200, 300) may be heated (1102) until it is pliable and moldable so that the fluid ejection device (200, 300) may be bent or curved. It is the thermoplastic material (302) and its pliability or moldability under heat that creates the curve (320) in the fluid ejection device (200, 300).

The specification and figures describe a fluid ejection device may include a plurality of fluid ejection dies coupled to a thermoset material and singulated, and a thermoplastic material coupled to the singulated, fluid ejection dies. The thermoplastic material may be bent to form a curvature in the fluid ejection device.

The systems and methods described herein provide a curved printhead that matches the radius of a print medium moved within a printing device over a roller. Since the overmolded dies are much narrower than other dies, it is much easier to integrate the dies in a curved and insert molded printhead. This curved printhead assists in minimizing the deviation of head-to-paper spacing and increase the usable print zone. As a result, the print quality is increased and print defects are minimized or eliminated. Further, a curved printhead provides tighter head to paper spacing control and a wider print zone, and reduces costs through a simplified paper path.

The preceding description has been presented to illustrate and describe examples of the principles described. This description is not intended to be exhaustive or to limit these principles to any precise form disclosed. Many modifications and variations are possible in light of the above teaching.

What is claimed is:

1. A fluid ejection module, comprising:
a plurality of fluid ejection dies coupled to a thermoset material and singulated; and
a thermoplastic material coupled to the singulated, fluid ejection dies,
wherein the thermoplastic material is bent to form a curvature in the fluid ejection module.

2. The fluid ejection module of claim 1, wherein singulation of the fluid ejection dies coupled to the thermoset material comprises cutting the thermoset material along the sides of the fluid ejection dies.

3. The fluid ejection module of claim 1, comprising ink feed channels formed in the thermoset material to feed a print fluid to the fluid ejection dies.

4. The fluid ejection module of claim 1, wherein the thermoset material is an epoxy mold compound (EMC).

5. The fluid ejection module of claim 1, wherein the thermoplastic material is an acrylic, poly(methyl methacrylate) (PMMA), acrylonitrile butadiene styrene (ABS), a nylon, polylactic acid (polylactide), polybenzimidazole (PBI), polycarbonate (PC), polyether sulfone (PES), polyoxymethylene (POM), polyether ether ketone (PEEK), polyetherimide (PEI), polyethylene (PE), polyphenylene oxide (PPO), polyphenylene sulfide (PPS), polypropylene (PP), polystyrene (PS), polyvinyl chloride (PVC), polytetrafluoroethylene (PTFE), polyethylene terephthalate (PET), polysulfone (PSU) or combination of the thermoplastic materials above.

6. The fluid ejection module of claim 1, wherein application of heat to the thermoplastic material causes the plurality of fluid ejection dies to be angled with respect to one another, the angle of the plurality of fluid ejection dies creating the curvature in the fluid ejection module.

7. A printing system, comprising:
a roller to convey a print medium; and
a fluid ejection module to eject fluid onto the print medium, the fluid ejection module comprising:
a plurality of fluid ejection dies coupled to a thermoset material and singulated; and
a thermoplastic material coupled to the singulated, fluid ejection dies,
wherein the thermoplastic material is bent to form a curvature in the fluid ejection module.

8. The printing system of claim 7, wherein the curvature in the fluid ejection module matches a radius of the print medium over the roller.

9. The printing system of claim 7, wherein the curve maintains each of the fluid ejection dies equidistant from the print medium.

10. A method of manufacturing a fluid ejection module, comprising:
coupling a plurality of fluid ejection dies to a thermoset material;
singulating the thermoset material around the fluid ejection dies;
coupling the singulated fluid ejection dies to a thermoplastic material; and
heating the thermoplastic material to cause the plurality of fluid ejection dies to be angled with respect to one another, the angle of the plurality of fluid ejection dies creating a curve in the fluid ejection module.

11. The method of claim 10, comprising forming a plurality of ink feed channels within the thermoset material to feed a print fluid to each of the fluid ejection dies.

12. The method of claim 11, comprising:
placing the thermoplastic material and singulated fluid ejection dies into a mold; and
heating the thermoplastic material,
wherein the mold defines the degree of curvature of the fluid ejection module.

13. The method of claim 11, wherein singulation of the overmolded fluid ejection dies comprises:
overmolding the plurality of fluid ejection dies within the thermoset material; and
cutting the thermoset material along the sides of the fluid ejection dies.

14. The method of claim 11, wherein the thermoset material is an epoxy mold compound (EMC).

15. The method of claim 11, comprising cooling the thermoplastic-overmolded fluid ejection dies while in the curved state.
